(19) United States
(12) Patent Application Publication
(10) Pub. No.: US 2012/0331023 A1
(43) Pub. Date: Dec. 27, 2012

(54) INTERACTIVE EXHIBITS

(75) Inventors: Aaron Eliezer Golden, San Francisco, CA (US); Kenneth Lorenz Knowles, Berkeley, CA (US)

(73) Assignee: Inkling Systems, Inc., San Francisco, CA (US)

(21) Appl. No.: 13/207,141

(22) Filed: Aug. 10, 2011

Related U.S. Application Data
(60) Provisional application No. 61/501,060, filed on Jun. 24, 2011.

(51) Int. Cl. G06F 3/048

(52) U.S. Cl. 708/138

(57) ABSTRACT

Disclosed in one example is a method for providing an interactive exhibit to a user. The method may include creating plotting instructions for an interactive exhibit based on an exhibit description and a value of a user adjustable visual element, the exhibit description comprising a mathematical function, and a description of a relationship between the user adjustable visual element and a parameter of the mathematical function. The method may also include causing the interactive exhibit to be displayed based on the plotting instructions, the interactive exhibit including the user adjustable visual element. In some examples, the method may also include determining that a user input corresponds to a change in the value of the user adjustable visual element and updating the displayed interactive exhibit based on the new value of the user adjustable visual element, the mathematical function and the relationship between the user adjustable visual element and the parameter of the mathematical function.

### PRIORITY CLAIM

This patent application claims the benefit of priority, under 35 U.S.C. Section 119(e) to U.S. Provisional Application Ser. No. 61/501,060, entitled “Interactive Exhibits,” filed on Jun. 24, 2011 to Golden, et. al. which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Standard Nine, d/b/a Inkling, All Rights Reserved.

### BACKGROUND

Traditional paper based textbooks utilize static figures to help students visualize educational materials. For example, a common lesson in introductory calculus courses describes the rule that the derivative of a function is zero at the local minima and maxima of the function. In order to assist students in visualizing this rule, the textbook may employ a static figure showing a function and the value of the derivative at various points of interest, such as the local minima and maxima. These points of interest are generally chosen by the textbook authors or editors and are representative of their subjective belief in the points of the figure that are important and helpful for students to visualize. The number of points of interest that may be shown is limited by space considerations as the static nature of the images allows for only a finite number of possible points.

### Overview

Disclosed in one example is a method for providing an interactive exhibit to a user. The method may include creating plotting instructions for an interactive exhibit based on an exhibit description and a value of a user adjustable visual element, the exhibit description comprising a mathematical function, and a description of a relationship between the user adjustable visual element and a parameter of the mathematical function. The method may also include causing the interactive exhibit to be displayed based on the plotting instructions, the interactive exhibit including the user adjustable visual element. In some examples, the method may also include determining that a user input corresponds to a change in the value of the user adjustable visual element and updating the displayed interactive exhibit based on the new value of the user adjustable visual element, the mathematical function and the relationship between the user adjustable visual element and the parameter of the mathematical function.

In another example, disclosed is a system for providing an interactive exhibit to a user. The system may include a parsing module configured to create plotting instructions for an interactive exhibit based on an exhibit description and a value of a user adjustable visual element, the exhibit description comprising a mathematical function, and a description of a relationship between the user adjustable visual element and a parameter of the mathematical function. In some examples the system may also include an output module configured to cause the interactive exhibit to be displayed based on the plotting instructions, the interactive exhibit including the user adjustable visual element. In some examples the system may also include an input module configured to receive a user input and determine that the input corresponds to a change in the value of the user adjustable visual element and in response, to update the displayed interactive exhibit based on the new value of the user adjustable visual element, the mathematical function and the relationship between the user adjustable visual element and the parameter of the mathematical function.

Disclosed in yet another example is a machine readable medium, which includes instructions which when executed causes a machine to perform various operations. In some examples, the operations may include creating plotting instructions for an interactive exhibit based on an exhibit description and a value of a user adjustable visual element, the exhibit description comprising a mathematical function, and a description of a relationship between the user adjustable visual element and a parameter of the mathematical function, the parsing being done on at least one computer processor, causing the interactive exhibit to be displayed based on the plotting instructions, the interactive exhibit including the user adjustable visual element, and determining that a user input corresponds to a change in the value of the user adjustable visual element and updating the displayed interactive exhibit based on the new value of the user adjustable visual element, the mathematical function and the relationship between the user adjustable visual element and the parameter of the mathematical function.

These examples may be combined in any permutation or combination. This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a screen shot of an interactive exhibit according to one example of the present disclosure.

FIG. 2 shows a screen shot of another interactive exhibit according to one example of the present disclosure.

FIG. 3a shows a listing of a description of an interactive exhibit according to one example of the present disclosure.

FIG. 3b shows a listing of a description of an interactive exhibit according to one example of the present disclosure.

FIG. 3c shows an example output of the interactive exhibit described by FIG. 3a and 3b according to one example of the present disclosure.

FIG. 4 shows a flow chart according to one example of the present disclosure.

FIG. 5 shows a system diagram of a client system according to one example of the present disclosure.

FIG. 6 shows a system diagram of an interaction service according to one example of the present disclosure.

FIG. 7 shows a schematic of a client device according to one example of the present disclosure.

FIG. 8 shows a machine implementation according to one example of the present disclosure.

### DETAILED DESCRIPTION

Explorative thinking is a useful educational tool that allows students to gain a better understanding of a topic by exploring that topic for themselves. Such exploration allows the student to construct their own cognitive model of the topic. This exploration often involves testing boundary conditions and assumptions as well as normal conditions. Current textbook based models and diagrams are limited in that they are able to present only a small set of subjectively chosen points of view of a particular model. Thus, for example, the orbit of the earth around the sun is determined by the mass of the sun, the velocity of the earth, and the distance between the earth and the sun. In a traditional textbook, the relationship between these factors and the orbit of the earth would likely be set out in an equation and one or more diagrams would be selected to visually show these relationships at selected points of emphasis. The student is left to interpolate their understanding of the model based upon one or two points.

Disclosed in one example is a method, system, and machine readable medium for displaying an electronic interactive exhibit. This electronic interactive exhibit may allow a user to interact with the exhibit through modification of one or more user adjustable dynamic visual elements. In some examples, these user adjustable dynamic visual elements may be associated with a mathematical function that may describe the exhibit, and modification of these user adjustable dynamic visual elements may modify the mathematical function or change its result or depiction. Modifying the mathematical function or its result may modify the interactive exhibit. In some examples, the exhibit may be updated in real-time in response to a change in one of the user adjustable dynamic visual elements. This may allow a user to manipulate various parts of the exhibit which may help the student to develop valuable intuitions for the subject of the exhibit without being constrained to one or two examples. In one example, this exhibit may be part of an interactive electronic learning textbook displayed on a computing device. In some examples, the interactive educational exhibit may be easily created by using an easy to use syntax that may be utilized by individuals with little or no computer programming expertise.

An interactive exhibit may be any two- or three-dimensional graphical display that may be represented or described by a mathematical function that allows user interaction through modification of at least one aspect of the mathematical function through user manipulation of one or more user adjustable dynamic visual elements associated with the display.

In some examples, the interactive exhibits may be or include mathematical plots of one or more mathematical functions. In some other examples, the interactive exhibit may not display the mathematical plot, but instead, display a series of one or more images or other graphics whose relationship to each other or to the screen, is defined by one or more mathematical functions. In some examples, one or more of these displayed images or other graphics may be a user adjustable dynamic visual element. In these examples, the user may not see the mathematical function, however, changing the user adjustable dynamic visual element may alter the relationship between the on-screen images or other graphics by altering the mathematical function or its results. In yet other examples, some exhibits may be defined by more than one mathematical function and some of the mathematical functions may be plotted, while others are simply used to determine the various relationships between other images.

In some examples, the user adjustable visual elements may allow a user to modify certain parameters or aspects of the mathematical function that describes the exhibit. These parameters or aspects include modification of the value of function constants, modification of one or more variables to explore the value of the function at certain values of the one or more variables, changes to the end result of the function to evaluate the state of variables at that point, changes to the range of values at which the function may be evaluated, changes to how the mathematical function is depicted, and the like.

In some examples, the user adjustable dynamic visual elements may be represented on-screen by a computer graphics sprite or other image. A computer graphics sprite may be a two-dimensional or three-dimensional image or animation that is integrated into a larger scene. The user adjustable visual elements may be adjusted using one or more of the input devices of the client. In some examples, this includes dragging or moving using a touch sensitive screen, other touch inputs, mouse inputs, keyboard inputs and the like.

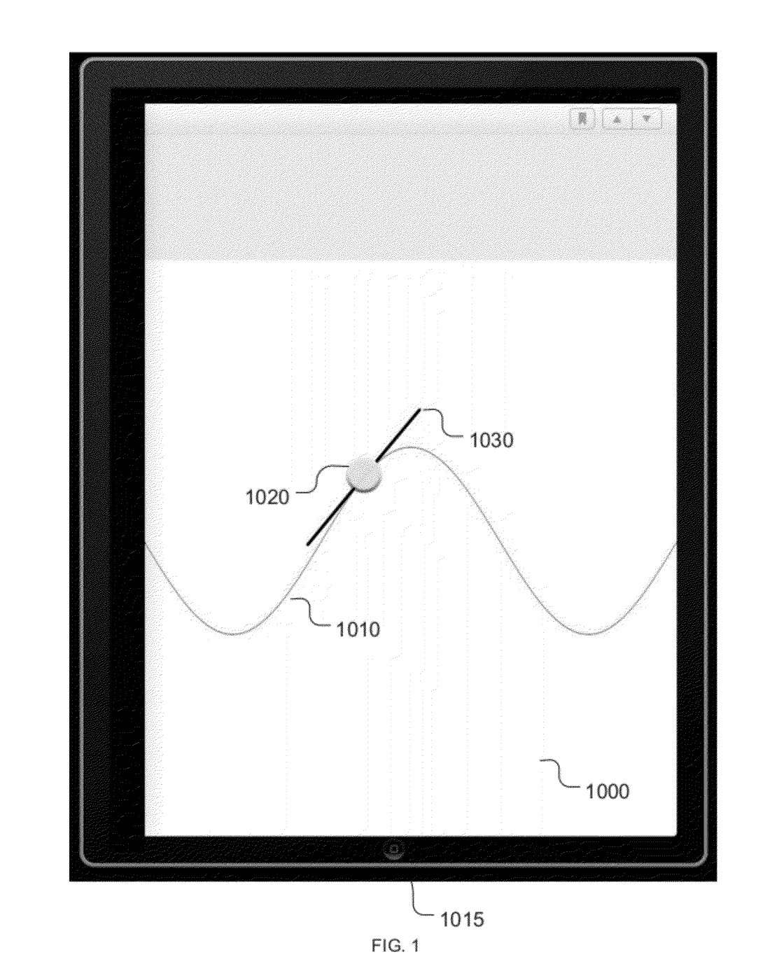

FIG. 1 shows one example interactive exhibit 1000. Shown is a mathematical function 1010 plotted on the screen of a tablet computer 1015. In the example of FIG. 1, the mathematical function 1010 may be sin(x) or cos(x). Also shown is a user adjustable dynamic visual element 1020. In this example, the user adjustable dynamic visual element is a white point that follows the path of the mathematical function 1010 and displays, at that point on the mathematical function, the first order derivative of the sin(x) or cos(x) function. The derivative at that point is displayed as a line plot 1030. Users may touch the white point 1020 with their finger (or an indicator associated with an input device, such as a mouse cursor) and drag the white point 1020 anywhere along the path of function 1010. When a user changes the position of the white point, the value of the derivative of the function 1010 changes. When the value of the derivative of the function 1010 changes, the line plot 1030 changes as well to reflect this change. This allows students to interact with the function 1010, learning the shape of the various derivative functions at any point along the mathematical function 1010 and not just points that a content creator deems important.

Students may explicitly see and interact with mathematical functions and plots in other similar ways, such as, but not limited to, changing slopes of lines, changing x and y intercepts, changing local minima and maxima, changing frequency and amplitude, changing constants, powers, derivatives, evaluating functions and variables at certain points, and the like. One example variable change case may include an interactive exhibit in which the student changes the “time” variable in a system of differential equations to see the system's state change over time.

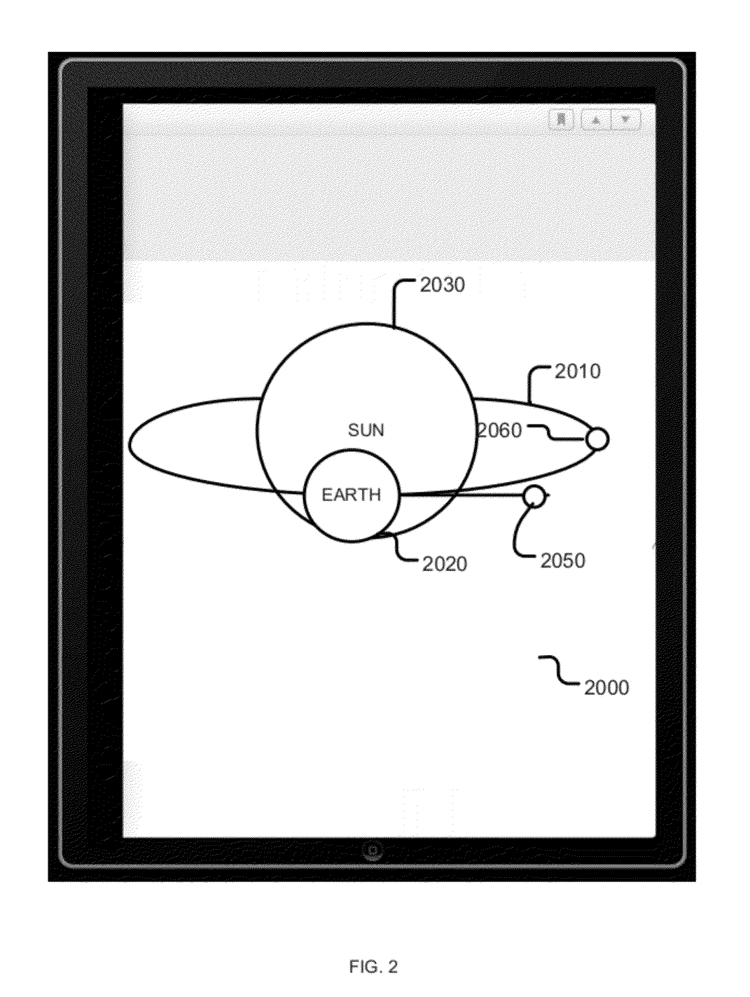

FIG. 2 shows another example interactive exhibit 2000. Shown is an orbit 2010 of the earth 2020 around the sun 2030. The earth 2020 is positioned in relation to the sun based upon a mathematical formula. In some examples, the earth 2020 may be animated such that it appears to the user to be rotating around the sun 2030 according to the orbit 2010. In other examples, the user may change the velocity of the earth 2020 by adjusting the adjustable dynamic visual element 2050 and watch as the orbit 2010 and in some examples, the speed of the orbit changes. In yet other examples, users may adjust the orbit itself and watch the results by adjusting the radius of the orbit by user adjustable dynamic visual element 2060. Other examples may include adjusting the size and mass of the sun 2030, the tilt of the earth 2020 about its axis, and any other parameter that affects the orbit of the earth 2020 around the sun 2030. These adjustments may give the user a better understanding of the various parameters that influence the orbit of the earth. It is to be appreciated that the examples disclosed herein are not intended to be limiting. For example, various interactive exhibits may display and allow dynamic interaction via one or more user adjustable dynamic visual elements between a user and a different object, such as other planets, comets, asteroids, and the like within the astronomy context. Interactive exhibits that enable dynamic interaction between a user and the exhibit may be available in other contexts as well, such as physics, chemistry, biology, engineering, and the like.

In some examples, the interactive exhibits may be incorporated into an electronic text book. These interactive exhibits may be created by content creators such as educators with little to no computer programming expertise. In some examples, the interactive exhibit may be described in a user friendly format such as XML. This user friendly XML may then be interpreted and executed by client software on the device itself. In some examples the client software executes on an electronic reader. An electronic reader may be any device which is capable of executing the client software which may render the electronic textbook and the electronic exhibits. In some examples, the electronic reader may be an IPAD®, manufactured by Apple, Inc. of Cupertino Calif., XOOM®, manufactured by Motorola, Inc., of Schaumburg, Ill., NOOK®, manufactured by Barnes and Noble, Inc. of New York, N.Y., KINDLE® manufactured by Amazon.com of Seattle, Wash., a laptop computer, a desktop computer, a tablet computer, or the like. In some examples, the calculations and processing of the electronic exhibit is done on the client device, while in other examples, various pieces of the process to display the interactive electronic exhibit may be performed on a separate device. For example, the calculations of where the various components of the exhibit and their layout are positioned and repositioned in response to a user adjusting one of the user adjustable dynamic visual elements may be done on a computer server and then sent as a webpage to a client device over a computer network. In such examples, the client device then displays the interactive exhibit using the layout and commands generated by the server. User updates are then sent to the server, which responds with updated layouts and commands to cause the interactive exhibit to update.

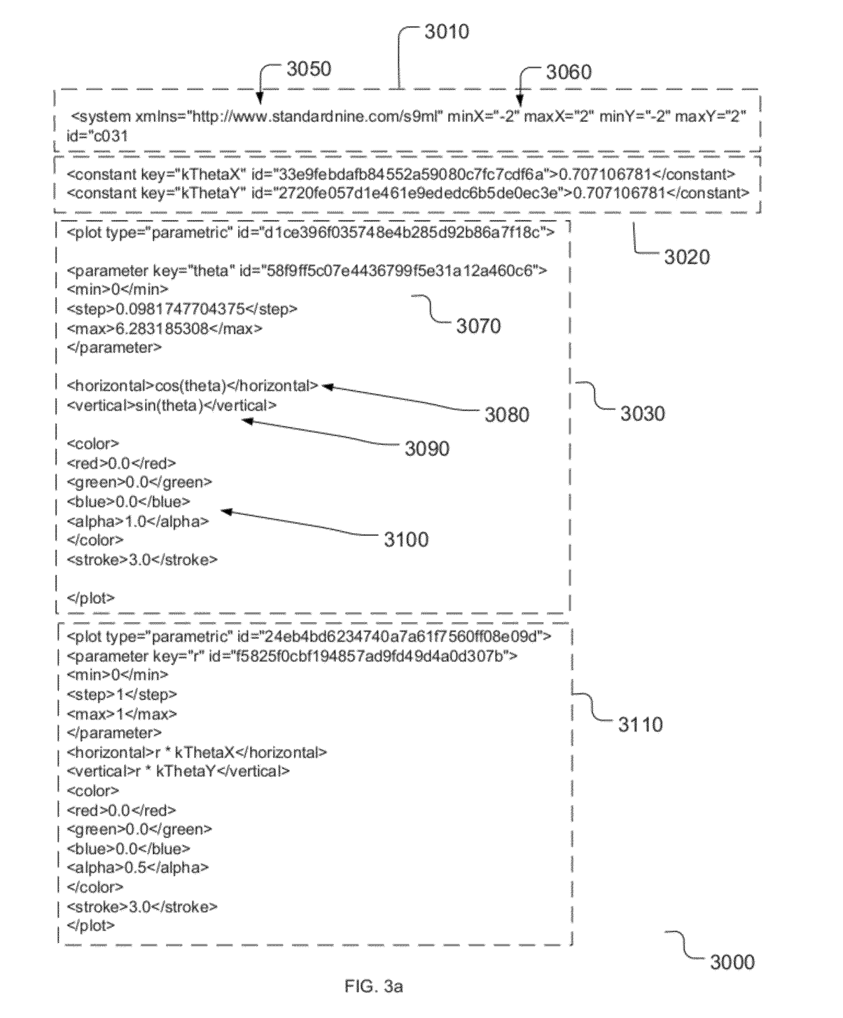

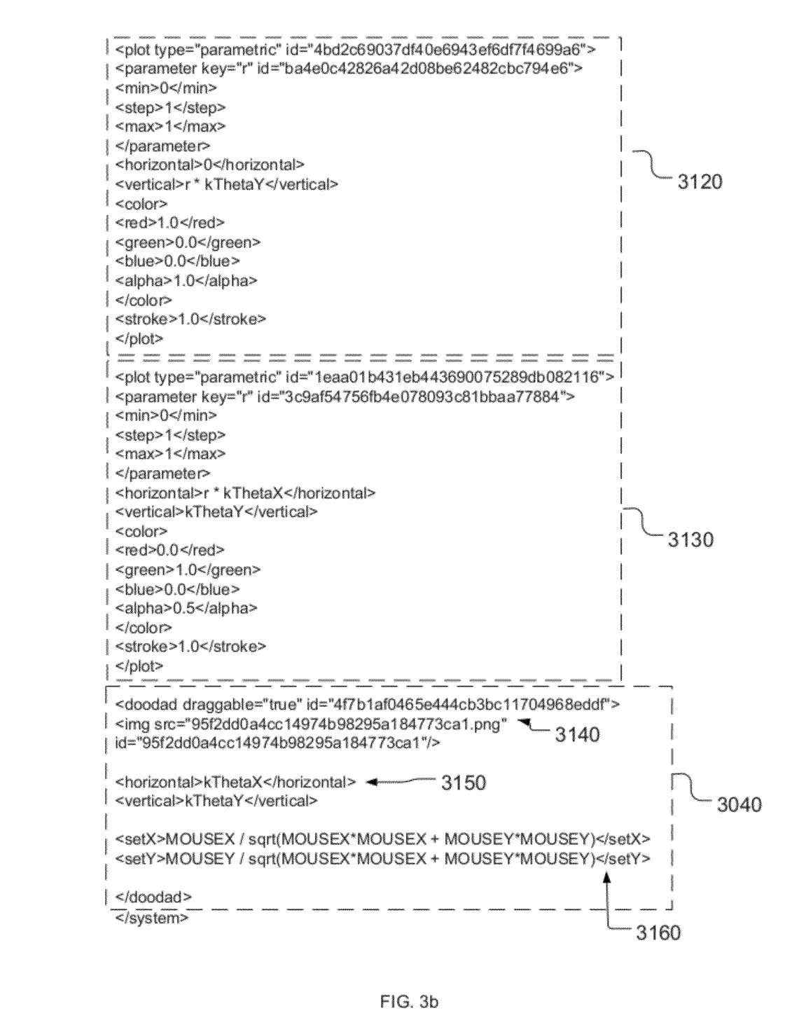

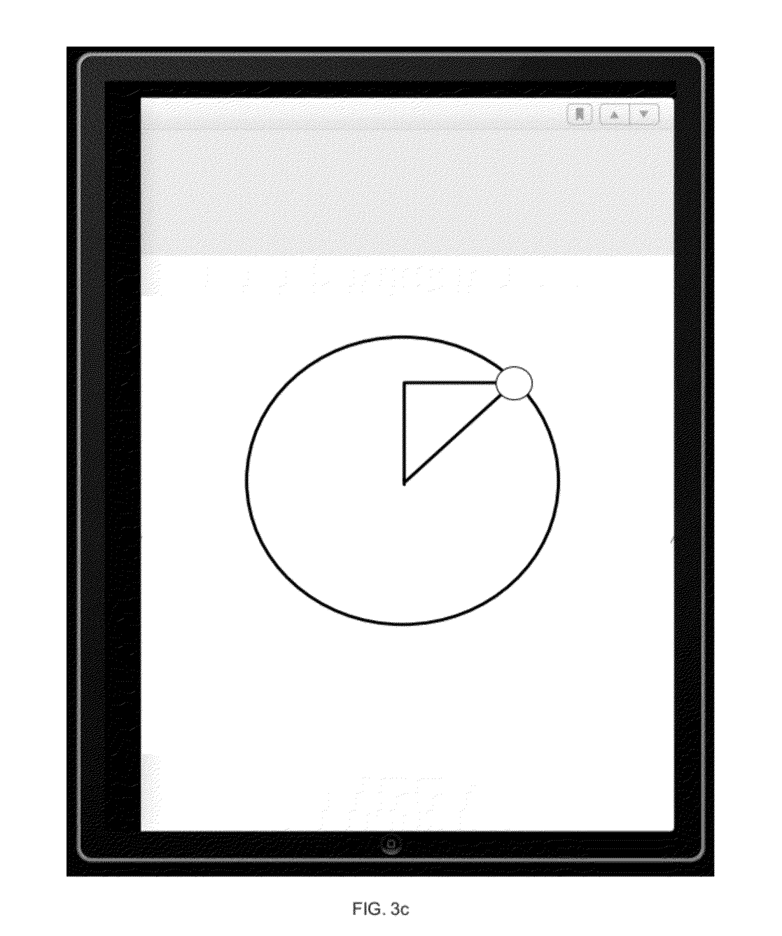

FIG. 3a and FIG. 3b shows one example of an interactive exhibit description 3000. While description 3000 is an XML description, the description may be in any format that adequately allows for the specification of the various mathematical functions, user adjustable dynamic visual elements, and formatting information. In some examples, the description 3000 may be a markup language, such as a proprietary markup language. In other examples, the description 3000 may be in some human readable natural language understandable by the client software through the use of an appropriate syntax. In yet other examples, the description 3000 may be implemented in computer code, such as C, C++, Java, Assembly or the like.

In some examples, the interactive exhibit description may contain a header 3010, descriptions of one or more constant or variable definitions 3020, descriptions of one or more function plots 3030, 3110, 3120, 3130, and descriptions of one or more user adjustable dynamic visual elements 3040.

In some examples, the header 3010 may include text 3050 (e.g., “system xmlns=”http://standardnine.com/s9 ml”) that identifies the description as an interactive exhibit or identifies the format of the exhibit description so that the interactive textbook client software may identify this as an exhibit and interpret the description properly. The header 3010 may also contain a section 3060 that defines parameters of a two- or three-dimensional coordinate space. In some examples, the parameters may be a minimum and maximum horizontal, vertical, and in the case of a three-dimensional exhibit, depth coordinates. In the example of FIG. 3a and b, the coordinate space is a two dimensional space with the horizontal, or x-value, ranging from −2 to +2 and the vertical, or y-value ranging from −2 to +2.

This coordinate space may be transformed by the client software or the client device operating system into screen space and back. Thus for example, if the client device is an IPad® manufactured by Apple Computer Co.® of Cupertino, Calif. which has a screen resolution of 1024×768, and if the interactive exhibit takes up the entire screen dimensions with a horizontal range of −2 to +2 and the vertical range of −2 to +2, an exhibit position of (−1,0) in some examples may correspond to an actual screen position of (256, 384). For purposes of the exhibit description however, any functions, variables, or constants defined may refer to the coordinate space defined in the header. In other examples, the exhibit may be defined in terms of screen space, thus the plot may be from (0,0) to (1024,768) and an exhibit position of (10,10) may be an actual screen position of (10,10).

Function plot descriptions 3030, 3110, 3120 and 3130 instruct the client software to plot one or more functions on the screen. In some examples, the functions may be described in parametric form. These functions may utilize one parameter (or variable) in two-dimensional space, and two parameters in three-dimensional space. The parameter description 3070 may specify the name of the parameter(s) (theta for function description 3030 in FIG. 3a, for example), the range of the parameter(s) with respect to the defined coordinate space (0-2* pi in FIG. 3a, for example), and the step of the parameter(s) (0.0981747704375 in FIG. 3a, for example).

The step value may be used in some examples by a mathematical parser used when plotting the function. The math parser may evaluate the function over a range of values producing a result that is then used to draw the exhibit. In some examples, the range is from the <min> value of the parameter, to the <max> value, incrementing by the <step> parameter. The step value may describe the quantity to increment the parameter between each evaluation of the parametric equation. As the math parser parses the function, it may be evaluated (max−min)/step times and when plotted, a line may connect each of the evaluated values. Thus for example a function may be described parametrically as:

<horizontal>2t+1</horizontal>
<vertical>t</vertical>

If the parameter “t” has a min of −2 and a maximum of 2 with a step of 1, the function may be evaluated at t={−2,−1,0,1,2} producing x={−3,−1,1,3,5} with y={−2,−1,0,1,2}. The (x,y) points (−3,−2), (−1,−1), (1,0), (3,1), and (5,2) may be plotted and a line may be drawn through each point to produce a continuous plot.

In FIG. 3a-b, four plots are shown. The first plot 3030 is that of a circle and is drawn in black. Function plot 3030 includes the horizontal component 3080 and the vertical component 3090. The horizontal function describes the value of the x point and the vertical function describes the value of the y point at a specific point of the parameter. For example, at theta=0, the value of x=cos(0)=1 and the value of y=sin(0)=0.

Function plot 3030 also includes a description section 3100 that describes formatting information describing how the function is to be plotted. In some examples, this may include the color, transparency (alpha), and line weight of the line that is to be plotted based on the function.

While the function is shown as a parametric equation, the mathematical equation could be described in other ways. For example, the equation could be described in the form of y=f(x), a table of values, differential equation, inverse function, or the like.

The second plot shown 3110 is a diagonal line drawn from the center of the circle to one of the edges of the circle. The third plot shown 5120 is a vertical line from the center of the circle upwards. The fourth plot 5130 is a horizontal line starting at kThetaY (a variable described in the variable or constant definitions 3020) and continuing horizontally until it meets with the circle and the diagonal line. The resulting plots are shown in FIG. 3c.

Adjustable dynamic visual element description 3040 describes the adjustable dynamic visual elements. The header 3140 includes configuration information on what visual image to display and whether the user may actually adjust the dynamic visual element (e.g. the “draggable” parameter). In some circumstances it might be desirable to avoid allowing the user to move this element. For example, it may be desirable to display a static image, or display an image that moves in dependence with a mathematical formula that may be adjusted using a different adjustable dynamic element.

The association description 3150 associates the adjustable dynamic visual element with a parameter, constant, or other variable from one of the plots. In the examples of FIG. 3a-c, the adjustable dynamic visual element's initial position is described by the parametric equation “<horizontal>kThetaX</horizontal>” and “<vertical>kThetaY</vertical>.” This also associates the position of the adjustable dynamic visual element with both kThetaX in the horizontal and kThetaY in the vertical. Moving the adjustable dynamic visual element in the horizontal direction will change the value of kThetaX and in the vertical direction will change kThetaY. The corresponding plots of the various line segments which utilize either or both of kThetaX and kThetaY may then be updated to reflect this change.

Each user adjustable dynamic visual element may update one or more parameters of one or more functions. Thus it may be possible for one user adjustable dynamic visual element to update multiple parameters within a single function, or update one parameter in multiple functions, or multiple parameters within multiple functions.

The restriction description 3160, in some examples, may restrict the path of the adjustable dynamic visual element to certain locations. In this example, MOUSEX and MOUSEY refer to the x and y coordinate of the destination position of the adjustable dynamic visual element after a user has attempted to drag the element to a different location. For example, if the user attempts to drag the user adjustable dynamic visual element from position −1 to position 1, prior to the screen updating the position of the user adjustable dynamic visual element, the client software may reference the restriction descriptions 3160 to determine exactly how the adjustable dynamic visual element may move. The client software may set the new X and Y values of the adjustable dynamic visual element according to the <setX> and <setY> functions and then use those coordinates to display the new position of the adjustable dynamic visual element on screen (and to update the other elements and graphs of the exhibit). If the designer of the exhibit does not want to implement any restrictions on the adjustable dynamic visual elements, the <setX> function may simply be “<setX>MOUSEX</setX>” and “<setY>MOUSEY</setY>.” In this way, the adjustable dynamic visual elements may be constrained to particular paths on the screen. For example, the white point 1020 in FIG. 1 was constrained to the path of function 1010.

In the example of FIG. 3, the adjustable dynamic visual element is constrained to the unit circle by the restriction description 3160. At the same time, moving the adjustable dynamic visual element around the unit circle adjusts the values of kThetaX and kThetaY. The four functions plotted include (1) a parametric function describing the unit circle 3030, (2) a parametric function describing a line segment from the origin to the point (x=kThetaX, y=kThetaY) 3110, (3) a parametric function describing only the horizontal component of equations (2), and (4) 3130, a parametric function describing only the vertical component of equation (2) 3120. The plot of functions (2), (3), and (4) change in response to the user adjusting the user adjustable dynamic visual element. The lengths of the line segments of functions (3) and (4) are the cosine and sine of the angle between the line segment of function (2) and the x-axis. This interactive exhibit is designed to help the student visualize the sine and cosine functions and in particular to help the student understand the relationship between sine and cosine and the relationship between those functions and the right triangle (visualized by plots 2, 3, and 4) embedded in the unit circle (plot 1).

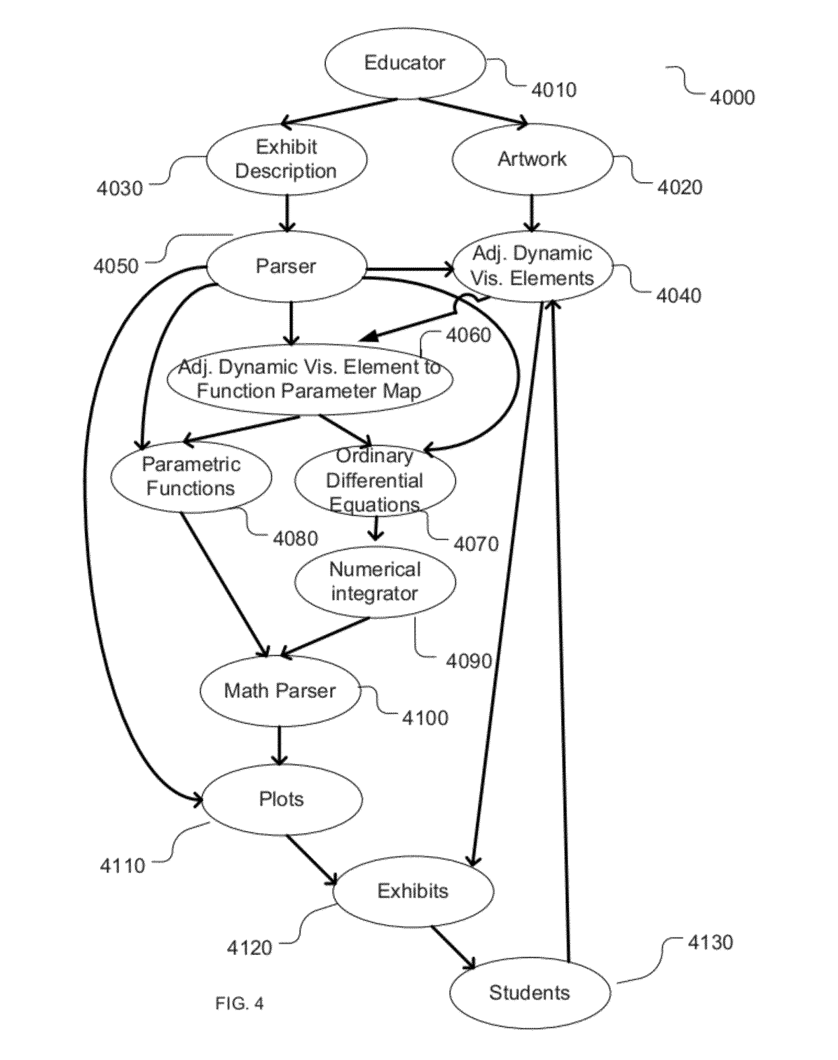

FIG. 4 shows one example method 4000 of processing the exhibit description. Educators or other content creators 4010 may create exhibit descriptions 4030 and corresponding artwork, graphics, and the like 4020, including graphics for the various adjustable dynamic visual elements 4040. Exhibit descriptions 4030 may be parsed by a parser 4050 to produce an internal representation of the exhibit descriptions. In some examples the internal representation may include a list of plot specifications including lists of variables and mathematical formulas contained in the internal representation as well as the mappings between the various adjustable dynamic visual elements and the function parameters 4060. Parametric equations 4080 may be passed directly to a mathematical parser 4100 where they are evaluated. Ordinary differential equations (ODE) 4070 may be passed to a numerical integrator where the differential equations are evaluated before the evaluated ODEs are passed to the mathematical parser 4100. The ODE equations may be evaluated for all the evaluation points specified by the parameters 3070 in the plot description. Mathematical parser 4100 may take the equations and the parsed exhibit descriptions and create plots 4110. Plots 4110 may be one or more instructions for displaying the interactive exhibit, including, but not limited to, drawing instructions either executable by the client software, or directly by the client device. Plots 4110 as displayed on the screen by the client may be exhibits 4120 which may be interacted with by students 4130.

Students 4130 may modify adjustable dynamic visual elements 4040. When a student modifies elements 4040, the desired new position of the adjustable dynamic visual element 4040 is passed to the client software as MOUSEX and MOUSEY or some other parameter. The client software then determines the new positions of the touch elements 4040 by referring to the <setx> and <sety> functions in the plot description. Once the new position of the user adjustable dynamic visual element 4040 is determined, the client software then determines which parameters of the interactive exhibit correspond to the user adjustable dynamic visual element that was modified. These parameters are then updated to reflect the new value of the user adjustable dynamic visual element 4040. The mathematical parser 4100 and/or the ODE 4070 are again called to re-evaluate the various mathematical equations of the interactive exhibit. This generates updated plot information 4110 which is then sent to the display of the client device, where the interactive exhibit 4120 is now updated to reflect the change in the parameters.

In some examples, it may be desirable for an instructor or content creator to provide more structure to a student's exploration of the exhibits. In some examples, the instructor or content provider may provide a guided tour for a user through specific points in the interactive exhibit. In some examples, this may be done by specifying an initial position for one or more of the adjustable dynamic visual elements. In other examples, the content creators or others may specify certain important positions of one or more of the adjustable dynamic visual elements or other elements of the interactive exhibit. In some examples, this may be done by creating list of a series of positions of one or more of the adjustable dynamic visual elements. Students or users 4130 may then navigate through these important points, and in some examples, also freely explore other values of the adjustable dynamic visual elements. In some examples, when a student navigates among the various important points, only the important point and the resulting exhibit is displayed, thus the changes in the exhibit from one important point to another is not shown—e.g. the exhibit may consist of a series of static positions. In other examples, the guided tour may be animated—thus the exhibit changes from one important point to another important point—showing an animation of the changes in the exhibit along the way.

In some examples, these guided tours may include notes or other audio, visual, or audiovisual commentary specific to each important point. These notes may highlight portions of the exhibit and give insight to the students 4130 or other users.

The guided tours may be navigable by the user based upon standard navigation buttons (forward, back, next, etc. . . . ), a timeline, a series of media buttons (e.g. play, stop, rewind, fast forward, pause, etc. . . . ) or the like. In some examples, only the important points may be displayed and free exploration by users or students 4130 is restricted. In yet other examples, both the guided tours and free exploration are permitted. In some examples, the points selected by the content creators or others may be displayed first, with free exploration available after the user has viewed the points selected by the content creators. In yet other examples, users may be able to switch between free mode and guided tour mode.

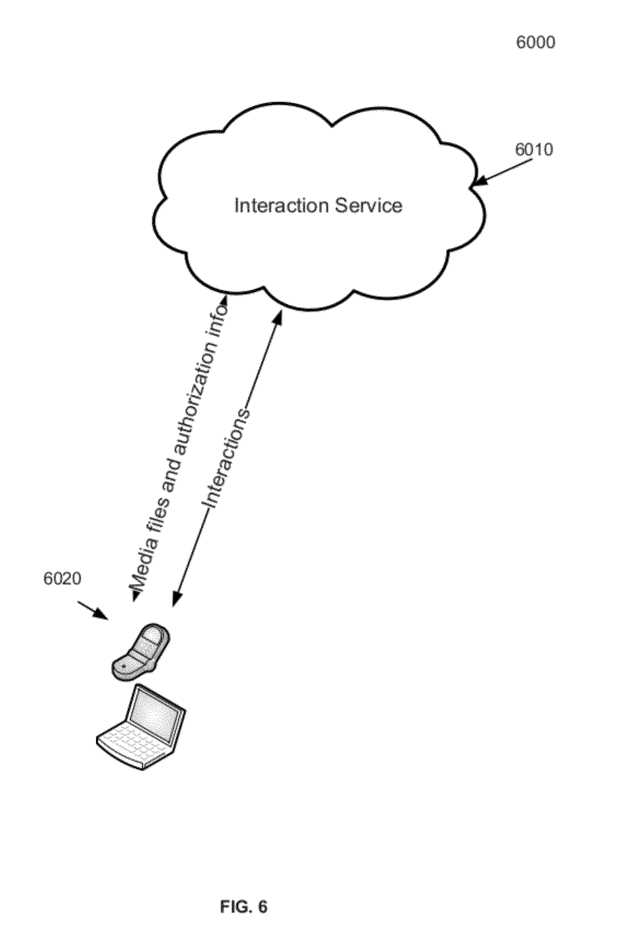

In some examples, a user of the interactive exhibit may record a particular manipulation of the user adjustable dynamic visual elements which may then be shared with other users of the user adjustable dynamic visual elements or with content creators or educators. These recordings may be in the form of a list of a series of positions of one or more of the adjustable dynamic visual elements, a recording of the entire sequence, a recording of the user inputs leading to the sequence, or a recording of the raw video frames of the sequence. These recordings may be accompanied by notes and other social interactions. These recordings may be shared by users by sending the recording, or information about the recording, to an interaction service 6010 (FIG. 6). Interaction service 6010 will be described in detail later.

In some examples, the interactive exhibits may be integrated with one or more assessments given to users. These assessments may ask the user questions about the interactive exhibit. For example, a user may be shown the interactive exhibit and asked to describe or select the effect of one or more changes on one or more of the dynamic adjustable visual elements. In some examples, the user may be asked to adjust one of the dynamic visual elements to a proper spot in response to a question. For example, the interactive exhibit of FIG. 1 may be made into an assessment where a user may be asked to drag the interactive adjustable element to a position at which the derivative of the function 1010 is zero, or some other value. In some examples, certain information may be hidden on the interactive exhibit so as to provide an effective assessment. In other examples, an interactive exhibit may be used as a supplement to a regular question and answer assessment to help explain the question or answer to a user.

In some examples, the interactive exhibit may record the various changes made by the user to the user adjustable dynamic elements. This data may then be sent to the interaction service 6010 where it may be shared with content creators or educators. In some examples, the data from many different users or students may be shared with content creators or educators. In other examples, the data may be aggregated and presented to content creators or educators. This may enable the content creators to design more effective exhibits and the educators to learn about areas of student or user interest.

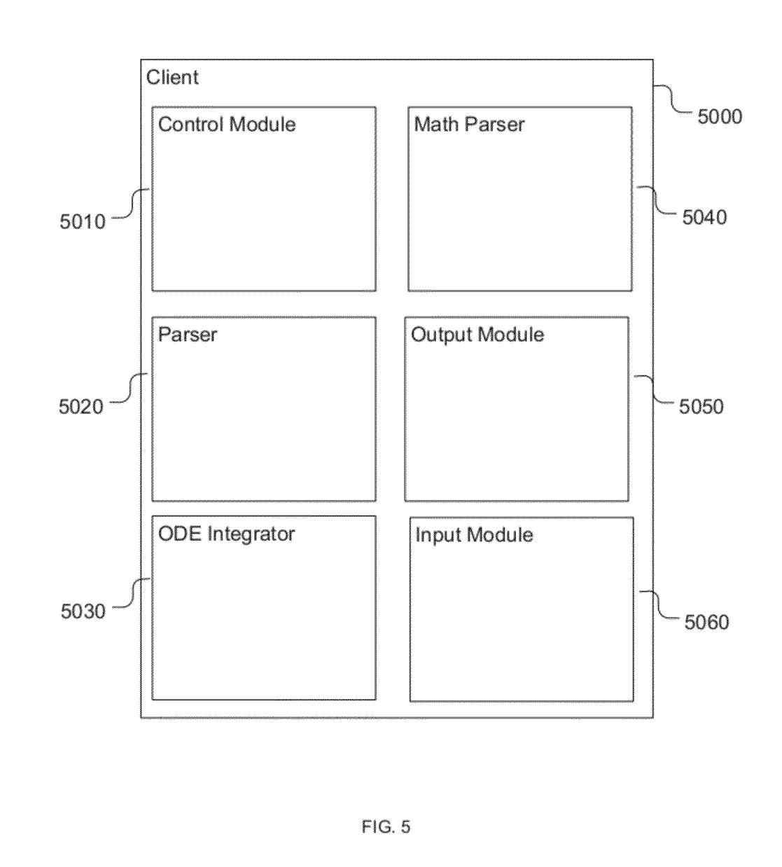

Turning now to FIG. 5, an example client device 5000 is shown. Control Module 5010, upon initiating the display of the exhibit, may pass the description of the interactive exhibit to display to the parser 5020. Parser 5020 may produce a series of plot specifications, as well as formatting information. The plot specifications describe the mathematical plots and the various interactive adjustable elements and their relations.

The plot specifications may be passed to a differential equation numerical integrator 5030 if the plot specifications specify ordinary differential equations. In some examples the numerical integrator 5030 may use Runge-Kutta methods, the Euler-Forward method, or any other method. In some examples, the Runge-Kutta method used may be fourth-order Runge-Kutta (RK4). The output of the numerical integrator 5030 may be a series of evaluated ordinary differential equations. Thus, for example, if the plot specification is for an ordinary differential equation of: {y(0)=1, y′(t,y)=t y+1}, and the parameters are {min t=0, max t=1, step size=0.2}, the numerical integrator will produce a series of values for y: {1.00, 1.22, 1.51, 1.87, 2.37, 3.06} and a series of values for t: {0.00, 0.20, 0.40, 0.60, 0.80, 1.00}. The output of the numerical integrator 5030 may be a table of explicit values for the variables in the ODE (and time). In the above example, there was just one variable (y) and time, and the output may be of the form:

t

| | 0.00 | 0.20 | 0.40 | 0.60 | 0.80 | 1.0 |
|---|---|---|---|---|---|---|
| y | 1.00 | 1.22 | 1.51 | 1.87 | 2.37 | 3.06 |

The output of the numerical integrator 5030 or any parametric equations in the plot specification may then be passed to the mathematical parser 5040 for evaluation of the mathematical functions. The parser evaluates the mathematical function for each step from the <min> values to the <max> values. These results may then be used by the control module 5010, along with other formatting information in the exhibit description, to create a plurality of drawing commands which may be used to draw the mathematical plot on-screen.

In the case of ODE equations, the variables and the time parameter from the output table may in turn be used in parametric equations, which the parser will evaluate substituting values from the table. So to continue the example above, the exhibit may have that ODE describing the variable y, and then use the variables t and y in a parametric equation {horizontal=t+y, vertical=y*y}, and the parser will evaluate “t+y” and “y*y”, substituting in each column from the table in turn to produce six drawing commands equivalent to:

1. Move to point (1.00, 1.00); //horizontal=t+y=0+1=1; vertical=y*y=1*1=1
2. Draw line to point (1.42, 1.49); //t+y=0.20+1.22=1.42; y*y=1.22*1.22=1.49
3. Draw line to point (1.91, 2.28);
4, Draw line to point (2.47, 3.50);
5. Draw line to point (3.17, 5.62);
6. Draw line to point (4.06, 9.36);

Control module 5010 may then cause the interactive exhibit to be displayed on the output device of the client using output module 5050. Output module 5050 may be responsible for working with the operating system of the client device to display the interactive exhibit. In other examples, the output module 5050, or any other module of the client 5000, may be part of the operating system of the client device. Input from the user is received, and in some examples, validated, by the input module 5060. Example inputs may include (but are not limited to), movements of the mouse, touch events on a touchscreen display, voice inputs, keyboard inputs, joystick inputs, touchpad inputs, and the like.

These inputs are then passed to the control module 5010 to determine if they correspond to an attempt by the user to manipulate one of the interactive adjustable dynamic elements. Some inputs corresponding to an attempt to manipulate one of the dynamic visual elements include touching the screen coordinates of one of the dynamic visual elements, touching the screen coordinates of one of the dynamic visual elements and dragging the user input device (e.g., finger, stylus) elsewhere, tapping the screen coordinates of a dynamic visual element, clicking the mouse when the pointer is over a dynamic visual element, clicking the mouse and dragging the mouse when the pointer is over a dynamic visual element, voice commands, and the like.

In some examples, certain user inputs may not correspond to an attempt by the user to interact with a dynamic visual element. For example, the user may be attempting to scroll horizontally or vertically within the page, navigate away from the page, or access other user interface features.

Once the input is determined to be an attempt by the user to interact with the dynamic visual element, the control module 5010 may determine, based upon adjustable dynamic visual element description 5040, how to update the on-screen position of the adjustable dynamic visual element and how to update one or more parameters of the mathematical plot based upon the updated adjustable dynamic visual element. Once the parameters are updated, the plot specs may be re-run through the mathematical parser 5020, which may produce an updated series of drawing commands to update the dynamic exhibit. These commands may then be used by the control module 5010, along with other formatting information to update the dynamic exhibit on the screen.

These interactive exhibits may be delivered as part of an electronic book, and may include certain social features. FIG. 6 shows one example of a system 6000 according to some examples including an interaction service 6010 and electronic reader devices 6020.

Content creators may create content, including interactive exhibits. This content may then be stored for download or delivery to electronic reader devices 6020 by interaction service 6010. Interaction service 6010 may also receive user interactions with the content created by the various users of the electronic reader device 6020 and may store these user interactions, and/or forward them to other users of electronic reader devices 6020, content creators, or other users. Communication between electronic reader devices 6020 and interaction service 6010 may be through an electronic network. In some examples this network may be the internet, LAN, WAN or any other network. The communication method may be by Ethernet, wireless LAN, cellular or any other communication method.

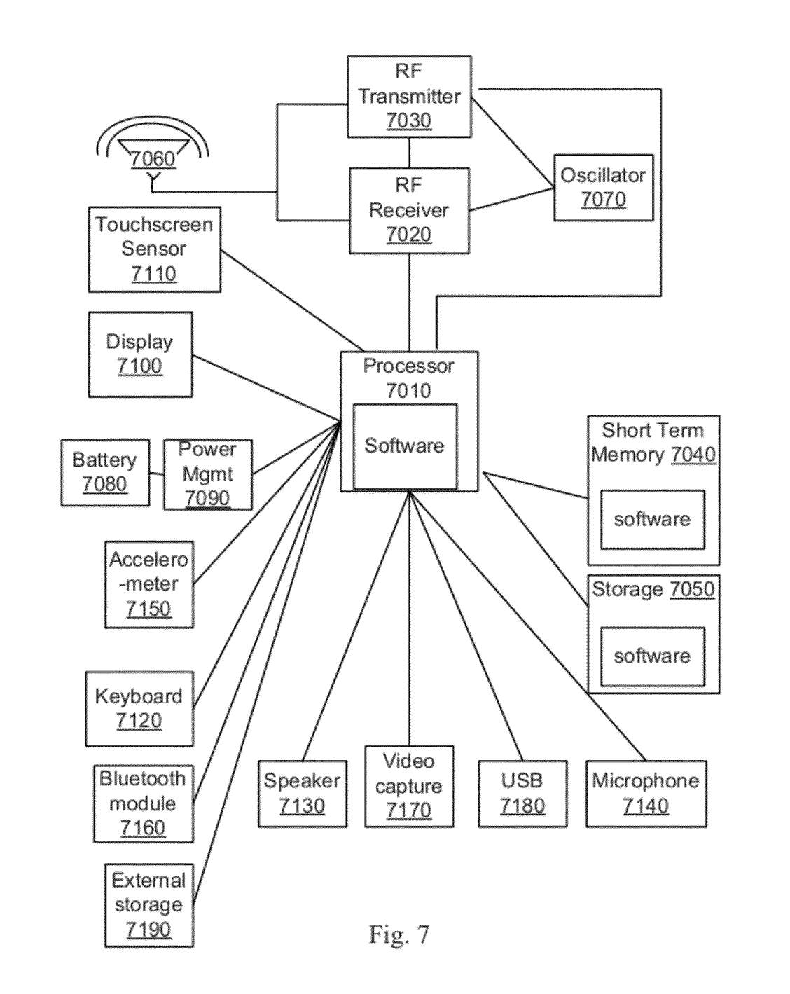

FIG. 7 shows some examples of such a device 7000 in the form of a tablet computer. Processor 7010 controls the overall functions of the tablet such as running applications and controlling peripherals. Processor 7010 may be any type of processor including RISC, CISC, VLIW, MISC, OISC, and the like. Processor 7010 may include a Digital Signal Processor (“DSP”). Processor 7010 may communicate with RF receiver 7020 and RF transmitter 7030 to transmit and receive wireless signals such as cellular, Bluetooth, and WiFi signals. Processor 7010 may use short term memory 7040 to store operating instructions and help in the execution of the operating instructions such as the temporary storage of calculations and the like. Processor 7010 may also use non-transitory storage 7050 to read instructions, files, and other data that requires long term, non-volatile storage.

RE Receiver 7020 and RF Transmitter 7030 may send signals to the antenna 7060. RF transmitter 7030 contains all the necessary functionality for transmitting radio frequency signals via. antenna 7060 given a baseband signal sent from Processor 7010. RF transmitter may contain an amplifier to amplify signals before supplying the signal to antenna 7060. RF transmitter 7030 and RF Receiver 7020 are capable of transmitting and receiving radio frequency signals of any frequency including, microwave frequency bands (0.3 to 70 GHz) which include cellular telecommunications, WLAN and WWAN frequencies. Oscillator 7070 may provide a frequency pulse to both RF Receiver 7020 and RF Transmitter 7030.

Device 7000 may include a battery or other power source 7080 with associated power management process or module 7090. Power management module 7090 distributes power from the battery 7080 to the other various components. Power management module 7090 may also convert the power from battery 7080 to match the needs of the various components. Power may also be derived from alternating or direct current supplied from a power network.

Processor 7010 may communicate and control other peripherals, such as LCD display 7100 with associated touch screen sensor 7110. Processor 7010 causes images to be displayed on LCD display 7100 and receives input from the touch screen sensor 7110 when a user presses on the touch-screen display. In some examples touch screen sensor 7110 may be a multi-touch sensor capable of distinguishing, and processing gestures.

Processor 7010 may receive input from a physical keyboard 7120. Processor 7010 may produce audio output, and other alerts which are played on the speaker 7130. Speaker 7130 may also be used to play voices (in the case of a voice phone call) that have been received from RF receiver 7020 and been decoded by Processor 7010. Microphone 7140 may be used to transmit a voice for a voice call conversation to Processor 7010 for subsequent encoding and transmission using RF Transmitter 709. Microphone 7140 may also be used as an input device for commands using voice processing software. Accelerometer 7150 provides input on the motion of the device 7000 to processor 7010. Accelerometer 7150 may be used in motion sensitive applications. Bluetooth module 7160 may be used to communicate with Bluetooth enabled external devices. Video capture device 7170 may be a still or moving picture image capture device or both. Video Capture device 7170 is controlled by Processor 7010 and may take and store photos, videos, and may be used in conjunction with microphone 7140 to capture audio along with video. USB port 7180 enables external connections to other devices supporting the USB standard and charging capabilities. USB port 7180 may include all the functionality to connect to, and establish a connection with an external device over USB. External storage module 7190 may include any form of removable physical storage media such as a flash drive, micro SD card, SD card, Memory Stick and the like. External storage module 7190 may include all the functionality needed to interface with these media.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Implementation

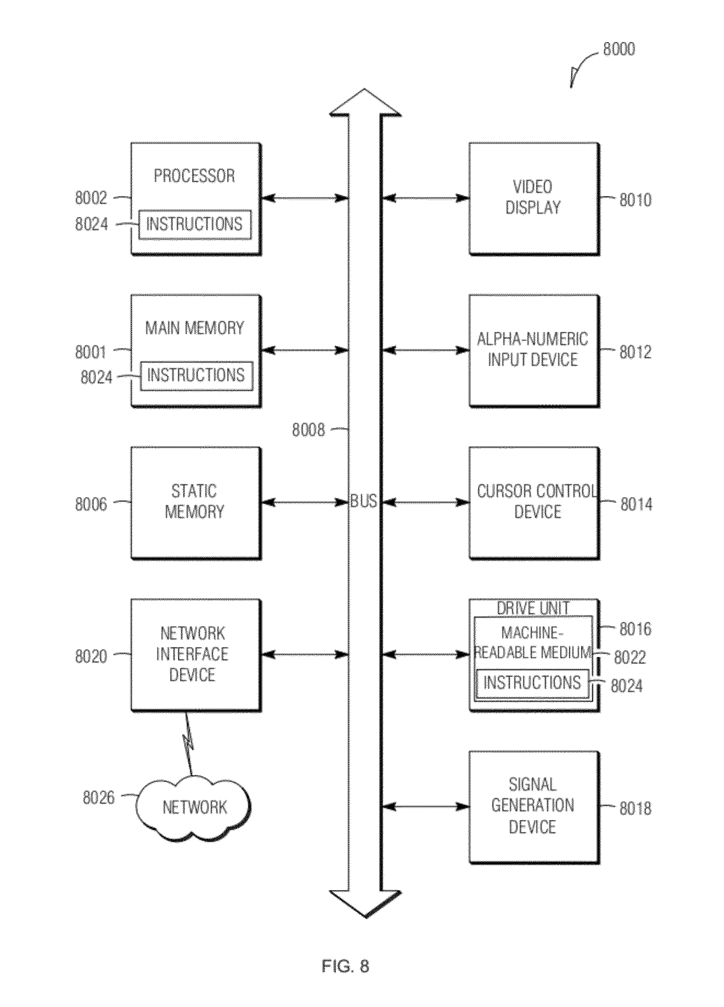

FIG. 8 shows a diagrammatic representation of a machine in the example form of a computer system 8000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 8000 includes a processor 8002 (e.g., a Central Processing Unit (CPU), a Graphics Processing Unit (GPU) or both), a main memory 8001 and a static memory 8006, which communicate with each other via a bus 8008. The computer system 8000 may further include a video display unit 8010 (e.g., a Liquid Crystal Display (LCD) or a Cathode Ray Tube (CRT)). The computer system 8000 also includes an alphanumeric input device 8012 (e.g., a keyboard), a User Interface (UI) cursor controller 8014 (e.g., a mouse), a disk drive unit 8016, a signal generation device 8018 (e.g., a speaker) and a network interface device 8020 (e.g., a transmitter).

The disk drive unit 8016 includes a machine-readable medium 8022 on which is stored one or more sets of instructions 8024 and data structures (e.g., software) embodying or used by any one or more of the methodologies or functions illustrated herein. The software may also reside, completely or at least partially, within the main memory 8001 and/or within the processor 8002 during execution thereof by the computer system 8000, the main memory 8001 and the processor 8002 also constituting machine-readable media.

The instructions 8024 may further be transmitted or received over a network 8026 via, the network interface device 8020 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

### Additional Notes

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A method for providing an interactive exhibit to a user comprising:
creating plotting instructions for an interactive exhibit based on an exhibit description and a value of a user adjustable visual element, the exhibit description comprising a mathematical function, and a description of a relationship between the user adjustable visual element and an aspect of the mathematical function, the parsing being done on at least one computer processor;
causing the interactive exhibit to be displayed based on the plotting instructions, the interactive exhibit including the user adjustable visual element;
determining that a user input corresponds to a change in the value of the user adjustable visual element and updating the displayed interactive exhibit based on the new value of the user adjustable visual element, the mathematical function and the relationship between the user adjustable visual element and the aspect of the mathematical function.

2. The method of claim 1, wherein the description of the relationship between the user adjustable visual element and the aspect of the mathematical function comprises a second mathematical function, and wherein the method further comprises restricting the visual element to be adjustable only in an onscreen path defined by the second mathematical function.

3. The method of claim 1, wherein the exhibit description is XML.

4. The method of claim 1, wherein the mathematical function is a parametric function described by both a horizontal component and a vertical component.

5. The method of claim 1, wherein creating the plotting instructions comprises evaluating the mathematical function over a range of values.

6. The method of claim 1, wherein the mathematical function is an ordinary differential equation.

7. The method of claim 6, wherein generating the plotting instructions comprises using a numerical integrator to evaluate the ordinary differential equation over a range of values.

8. The method of claim 1, wherein the value of the user adjustable visual element is based upon a position of the user adjustable visual element.

9. The method of claim 1, wherein the interactive exhibit is displayed as part of an interactive electronic textbook.

10. A system for providing an interactive exhibit to a user comprising:
a parsing module configured to create plotting instructions for an interactive exhibit based on an exhibit description and a value of a user adjustable visual element, the exhibit description comprising a mathematical function, and a description of a relationship between the user adjustable visual element and art aspect of the mathematical function;
an output module configured to cause the interactive exhibit to be displayed based on the plotting instructions, the interactive exhibit including the user adjustable visual element;
an input module configured to receive a user input and determine that the input corresponds to a change in the value of the user adjustable visual element and in response, to update the displayed interactive exhibit based on the new value of the user adjustable visual element, the mathematical function and the relationship between the user adjustable visual element and an aspect of the mathematical function.

11. The system of claim 10, wherein the description of the relationship between the user adjustable visual element and the aspect of the mathematical function comprises a second mathematical function, and wherein the user input module is further configured to restrict the visual element to be adjustable only in an onscreen path defined by the second mathematical function.

12. The system of claim 10, wherein the exhibit description is XML.

13. The system of claim 10, wherein the mathematical function is a parametric function described by both a horizontal component and a vertical component.

14. The system of claim 10, wherein the parsing module is configured to create the plotting instructions based on the exhibit description and the value of a user adjustable visual element by evaluating the mathematical function over a range of values.

15. The system of claim 10, wherein the mathematical function is an ordinary differential equation.

16. The system of claim 15, wherein the parsing module is configured to create the plotting instructions based on the exhibit description and the value of a user adjustable visual element by using a numerical integrator to evaluate the ordinary differential equation over a range of values.

17. The system of claim 10, wherein the value of the user adjustable visual element is based upon the position of the user adjustable visual element.

18. The system of claim 10, wherein the interactive exhibit is displayed as part of an interactive electronic textbook.

19. A machine readable medium, which includes instructions which when executed cause a machine to perform the operations of:
creating plotting instructions for an interactive exhibit based on an exhibit description and a value of a user adjustable visual element, the exhibit description comprising a mathematical function, and a description of a relationship between the user adjustable visual element and an aspect of the mathematical function, the parsing being done on at least one computer processor;
causing the interactive exhibit to be displayed based on the plotting instructions, the interactive exhibit including the user adjustable visual element;
determining that a user input corresponds to a change in the value of the user adjustable visual element and updating the displayed interactive exhibit based on the new value of the user adjustable visual element, the mathematical function and the relationship between the user adjustable visual element and the aspect of the mathematical function.

20. The machine readable medium of claim 19, wherein the description of the relationship between the user adjustable visual element and the aspect of the mathematical function comprises a second mathematical function, and wherein the operations further comprise restricting the visual element to be adjustable only in an onscreen path defined by the second mathematical function.

21. The machine readable medium of claim 19, wherein the exhibit description is XML.

22. The machine readable medium of claim 19, wherein the mathematical function is a parametric function and is described by both a horizontal component and a vertical component.

23. The machine-readable medium of claim 19, wherein creating the plotting instructions comprises evaluating the mathematical function over a range of values.

24. The machine-readable medium of claim 19, wherein the mathematical function is an ordinary differential equation.

25. The machine-readable medium of claim 24, wherein generating the plotting instructions comprises using a numerical integrator to evaluate the ordinary differential equation over a range of values.

26. The machine-readable medium of claim 19, wherein the value of the user adjustable visual element is based upon the position of the user adjustable visual element.

27. The machine-readable medium of claim 19, wherein the interactive exhibit is displayed as part of an interactive electronic textbook.

28. A method, comprising:
generating an interactive exhibit from an exhibit description, the interactive exhibit including one or more graphical depictions and one or more user adjustable visual elements, the one or more graphical depictions corresponding to one or more concepts, the one or more user adjustable visual elements each associated with a graphical depiction and having a value tied to an aspect of the one or more graphical depictions;
causing the interactive exhibit to be displayed;
detecting a user manipulation of a user adjustable visual element in the displayed interactive exhibit, the user manipulation causing one of a change in the value of the user adjustable visual element and a change in the graphical depiction associated with the user adjustable visual element;
re-generating the interactive exhibit to account for the user manipulation of the user adjustable visual element; and
causing the regenerated interactive exhibit to be displayed.
